(19) United States
(12) Patent Application Publication
(10) Pub. No.: US 2013/0324071 A1
(43) Pub. Date: Dec. 5, 2013

(54) MODIFYING ALERT MODES FOR ELECTRONIC DEVICES

(71) Applicant: Yeung Hwae Huh, Morgan Hill, CA (US)

(72) Inventor: Yeung Hwae Huh, Morgan Hill, CA (US)

(21) Appl. No.: 13/487,709

(22) Filed: Jun. 4, 2012

(51) Int. Cl. H04W 4/22

(52) U.S. Cl. 455/404.1

(57) ABSTRACT

Embodiments of the present invention relate to an electronic device and/or program therefor configured to modify alert modes of the electronic device. Specifically, based on at least one predetermined criterion (e.g., a set of time coordinates, a calendar entry, etc.), a reduced alert mode may be activated in which the electronic device may be silenced or subject to a reduced volume. However, when a communication attempt is received on the device, the sender thereof will be identified and compared to a list of approved senders. If the sender is an approved sender, the reduced alert mode will be deactivated. In alternative embodiments, the reduced alert mode may be deactivated when an emergency call is received, and/or a predetermined number of communication attempts have been received from a single sender. In yet another embodiment, the electronic device may be placed in a heightened alert mode.

### FIELD OF THE INVENTION

In general, embodiments of the present invention relate to alert mode modification. Specifically, embodiments of the present invention relate to the modification of alert modes (e.g., activating/deactivating silent timers) for electronic devices (e.g., mobile devices, tablets, laptops, etc.).

### BACKGROUND OF THE INVENTION

With the proliferation of mobile devices, interruptions of others have drastically increased. It has become commonplace for places of worship, meeting venues, theaters, etc., to have an announcement prior to an event directing all attendees to turn off or silence such devices to avoid interruption of the event. Unfortunately, activation of a silent or reduced alert setting/mode is typically manual (as is subsequent deactivation). With such an implementation, interruptions still occur and/or important alerts are still missed. Heretofore, the following attempts have been made to provide solutions:

U.S. Pat. No. 8,055,306 discloses an alert system for mobile phones that searches out a second network for alerting the mobile phone user if an attempt on a first network is unsuccessful.

U.S. Pat. No. 7,911,334 discloses an alert system for personal electronic devices related to emergency alert periods.

U.S. Pat. No. 7,671,756 discloses a portable electronic device method that silences or modifies alerts based upon a user physically contacting the device.

U.S. Patent Application 20080207263 discloses an automatic mobile electronic device feature that changes a device's “notification profile” based upon a timer mechanism.

U.S. Patent Application 20070275767 discloses a method for temporarily changing an electronic device's notification profile settings.

U.S. Pat. No. 8,126,479 discloses a location-based mobile alert system.

U.S. Pat. No. 7,627,351 discloses a secondary cellular phone alert device that can alert a user to a phone call even when the primary device is not within close proximity.

U.S. Pat. No. 7,624,172 discloses a computer based communication system management alert that matches alerts to a particular alert feed.

U.S. Pat. No. 7,433,714 discloses a method for alert communications that includes a priority mechanism for managing the activation and display of alerts.

U.S. Pat. No. 7,333,776 discloses a secondary electronic device that can alert a user when the primary electronic device is separated by a predetermined distance.

U.S. Pat. No. 7,305,257 discloses a secondary device for communication with the primary device. This secondary device is used to alert the user of a communication to the primary device.

U.S. Patent Application 20110270940 discloses an electronic device alert notification method that is location based.

U.S. Patent Application 20110248863 discloses a location-based electronic device alert method.

U.S. Patent Application 20100216509 discloses a portable electronic device that prevents functionality when the device is moving.

U.S. Patent Application 20090215498 discloses a method for altering the display of a mobile electronic device that can be automatically changed based upon a schedule.

U.S. Patent Application 20070129113 discloses an apparatus for minimizing the probability of a user from losing a cell phone.

U.S. Patent Application 20070014244 discloses a method for managing notifications to server users.

### SUMMARY OF THE INVENTION

In general, embodiments of the present invention relate to an electronic device and/or program therefor configured to modify alert modes of the electronic device. Specifically, based on at least one predetermined criterion (e.g., a set of time coordinates, a calendar entry, etc.), a reduced alert mode may be activated in which the electronic device may be silenced or subject to a reduced volume. However, when a communication attempt is received on the device, the sender thereof will be identified and compared to a list of approved senders. If the sender is an approved sender, the reduced alert mode will be deactivated. In alternative embodiments, the reduced alert mode may be deactivated when an emergency call is received and/or a predetermined number of communication attempts have been received from a single sender. In yet another embodiment, the electronic device may be placed in a heightened alert mode (e.g., during certain time periods, for communication attempts from certain contacts, during visits to noisy locations such as construction sites, etc.).

A first aspect of the present invention provides a method for modifying alert modes of electronic devices, comprising: activating a reduced alert mode for an electronic device in response to at least one predetermined criterion, the reduced alert mode reducing a sound emitted from the electronic device; receiving a communication attempt on the electronic device; identifying a sender of the communication attempt; determining if the sender is on a list of approved senders; and deactivating the reduced alert mode of the electronic device responsive to the sender being on the list of approved senders.

A second aspect of the present invention provides an electronic device, comprising: a memory medium comprising instructions; a bus coupled to the memory medium; and a processor coupled to the bus that when executing the instructions causes the electronic device to: activate a reduced alert mode for the electronic device in response to at least one predetermined criterion, the reduced alert mode reducing a sound emitted from the electronic device; receive a communication attempt on the electronic device; identify a sender of the communication attempt; determine if the sender is on a list of approved senders; and deactivate the reduced alert mode of the electronic device responsive to the sender being on the list of approved senders.

A third aspect of the present invention provides a computer program product for modifying alert modes of electronic devices, the computer program product comprising a computer readable storage media, and program instructions stored on the computer readable storage media, to: activate a reduced alert mode for an electronic device in response to at least one predetermined criterion, the reduced alert mode reducing a sound emitted from the electronic device; receive a communication attempt on the electronic device; identify a sender of the communication attempt; determine if the sender is on a list of approved senders; and deactivate the reduced alert mode of the electronic device responsive to the sender being on the list of approved senders.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an electronic device according to an embodiment of the present invention.

FIG. 2 depicts a method flow diagram according to an embodiment of the present invention.

FIG. 3 depicts a method flow diagram according to an embodiment of the present invention.

FIG. 4 depicts a method flow diagram according to an embodiment of the present invention.

FIG. 5 depicts a method flow diagram according to an embodiment of the present invention.

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention relate to an electronic device (e.g., mobile device, tablet, computer, etc.) and/or program therefor configured to modify alert modes of the electronic device. Specifically, based on at least one predetermined criterion (e.g., a set of time coordinates, a calendar entry, etc.), a reduced alert mode may be activated in which the electronic device may be silenced or subject to a reduced volume. However, when a communication attempt is received on the device, the sender thereof will be identified and compared to a list of approved senders. If the sender is an approved sender, the reduced alert mode will be deactivated. In alternative embodiments, the reduced alert mode may be deactivated when an emergency call is received and/or a predetermined number of communication attempts have been received from a single sender. In yet another embodiment, the electronic device may be placed in a heightened alert mode (e.g., during certain time periods, for communication attempts from certain contacts, during visits to noisy locations such as construction sites, etc.).

Embodiments are described herein with reference to cross-sectional or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein, but are to include deviations in shapes that result, for example, from manufacturing. For example, an edge or corner region illustrated as having sharp edges may have somewhat rounded or curved features. Likewise, elements illustrated as circular or spherical may be oval in shape or may have certain straight or flattened portions. Thus, the regions illustrated in the figures are schematic in nature, and their shapes are not intended to illustrate the actual shape of a region or element of a device and are not intended to limit the scope of the disclosed embodiments.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

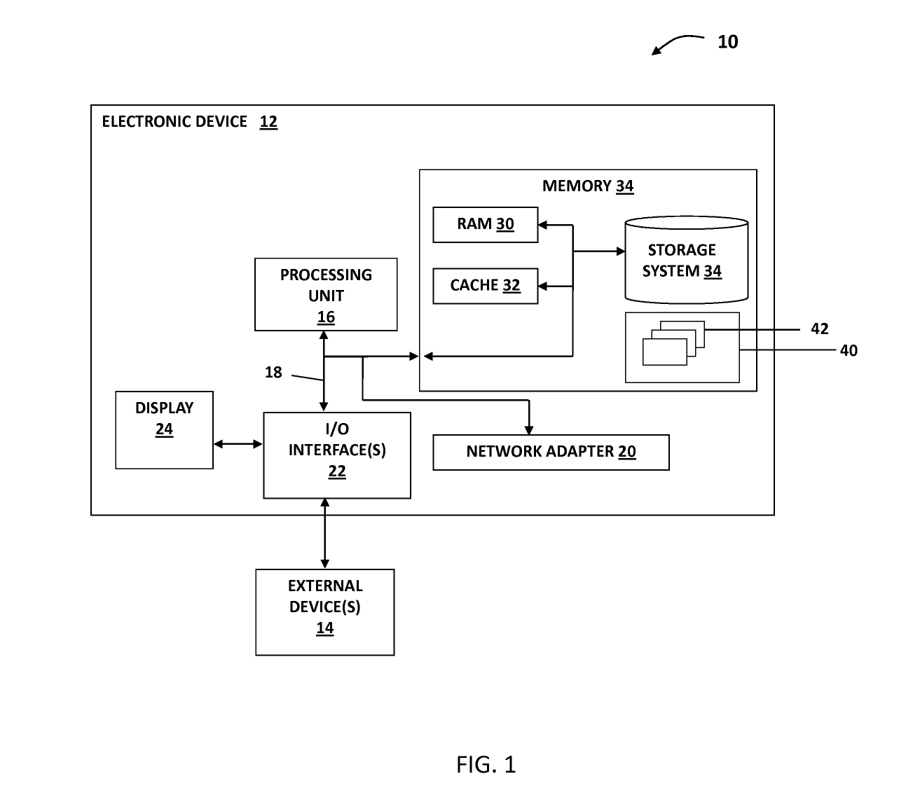

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth herein.

In computing node 10, there is an electronic/user device 12, which is operational with numerous other general purpose or special purpose computing system environments or configurations. Examples of well-known computing systems, environments, and/or configurations that may be suitable for use with electronic device 12 include, but are not limited to, personal computer systems, server computer systems, thin clients, thick clients, hand-held or laptop devices, cellular phones, tablets, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Electronic device 12 may be described in the general context of computer system-executable instructions, such as program modules, being executed by a computer system. Generally, program modules may include routines, programs, objects, components, logic, data structures, and so on, which perform particular tasks or implement particular abstract data types. Electronic device 12 may be practiced in distributed computing environments where tasks are performed by remote processing devices that are linked through a communications network. In a distributed computing environment, program modules may be located in both local and remote computer system storage media including memory storage devices.

As shown in FIG. 1, electronic device 12 in computing node 10 is shown in the form of a general-purpose computing device. The components of electronic device 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Electronic device 12 typically includes a variety of computer system readable media. Such media may be any available media that is accessible by electronic device 12, and it includes both volatile and non-volatile media, removable and non-removable media.

System memory 28 can include computer system readable media in the form of volatile memory, such as random access memory (RAM) 30 and/or cache memory 32. Electronic device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Device program/utility 40, having a set (at least one) of program modules 42, may be stored in memory 28 by way of example, and not limitation, as well as an operating system, one or more application programs, other program modules, and program data. In general, device program 40 performs the function of the present invention as described herein as well as all functionality traditionally provided by mobile devices as known in the art. Each of the operating system, one or more application programs, other program modules, and program data or some combination thereof, may include an implementation of a networking environment. Program modules 42 generally carry out the functions and/or methodologies of embodiments of the invention as described herein.

Electronic device 12 may also communicate with one or more external devices 14 such as a keyboard, a pointing device, a display 24, etc.; one or more devices that enable a consumer to interact with electronic device 12; and/or any devices (e.g., network card, modem, etc.) that enable electronic device 12 to communicate with one or more other computing devices. Such communication can occur via I/O interfaces 22. Still yet, electronic device 12 can communicate with one or more networks such as a local area network (LAN), a general wide area network (WAN), and/or a public network (e.g., the Internet) via network adapter 20. As depicted, network adapter 20 communicates with the other components of electronic device 12 via bus 18. It should be understood that although not shown, other hardware and/or software components could be used in conjunction with electronic device 12. Examples include, but are not limited to: microcode, device drivers, redundant processing units, external disk drive arrays, RAID systems, tape drives, and data archival storage systems, etc.

As discussed above, electronic device 12 comprises device program 40 having modules 42. Modules generally carry out the functionality discussed herein such as: activate a reduced alert mode for an electronic device in response to at least one predetermined criterion (e.g., a set of time coordinates such as a start and end time, a time period associated with a calendar entry accessible to the electronic device, etc.), the reduced alert mode reducing a sound emitted from the electronic device; receive a communication attempt on the electronic device; identify a sender of the communication attempt; determine if the sender is on a list of approved senders; deactivate the reduced alert mode of the electronic device responsive to the sender being on the list of approved senders; deactivate the reduced alert mode after a predetermined number of missed communication attempts from a single sender; indicate, after the reduced mode has been deactivated, a set of communication attempts received during the reduced alert mode; deactivate the reduced alert mode in response to a received emergency communication; and/or activate a heightened alert of the electronic device mode in response to a predetermined condition, the heightened alert mode increasing the sound emitted from the electronic device.

As such, embodiments of the present invention thereby provide for modifiable/configurable alert profiles/modes for electronic device 12. Such modes can be normal, reduced (e.g., lower volume/silent for when the user is in a meeting, religious service, theater etc.)), or heightened (e.g., increased volume for when a user is at a construction site or the like). The modes can be activated/deactivated based on previously established calendar entries and/or time coordinates.

### ILLUSTRATIVE EXAMPLES

This section will describe an illustrative example that is enabled and/or implemented by program 40 and/or modules 42. In an illustrative example, assume the mode being activated is a reduced alert mode referred to herein as a silent mode or “silent timer.” In general, the silent timer provides a user with the control to set up a silent mode with automatic return to the previous mode or normal mode. Moreover, the silent timer can set any silent mode periods in a day, any day of the week, and/or any day of the month or year as multiple occurrences in a calendar schedule. Still yet, the silent timer may be implemented in many ways. For example, the silent timer function can be added in the existing sound controller function (possibly to set one time for how long) and in the existing calendar schedule function for scheduled timer set.

In a typical embodiment, the silent timer will generate an alert if there are missed calls during the silent mode period at the silent timer end time. As indicated above, the silent timer may set emergency calls to a wake up silent mode. By turning on a “wake up silent” feature, even if it is in the silent mode. If someone attempts to communicate with the user repeatedly for some predetermined number of times, the electronic device may ring to be answered (e.g., silent mode may be deactivated).

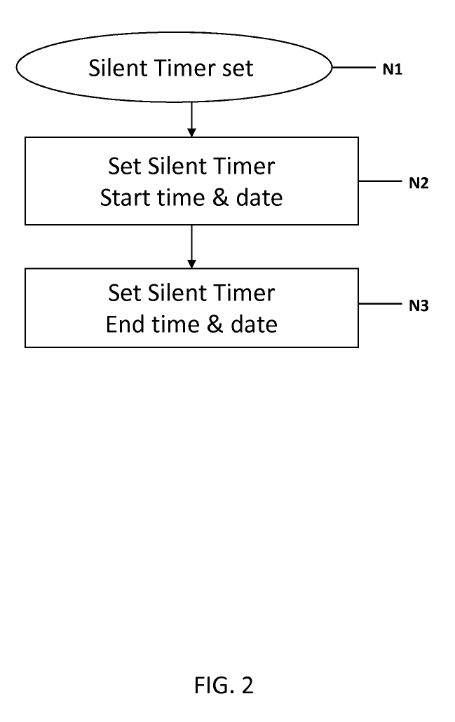

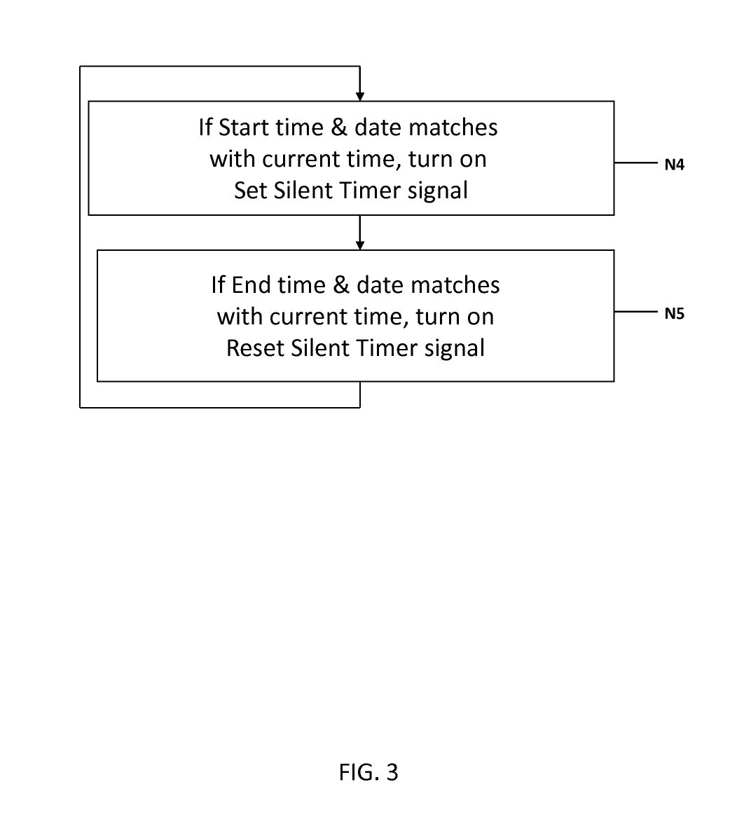

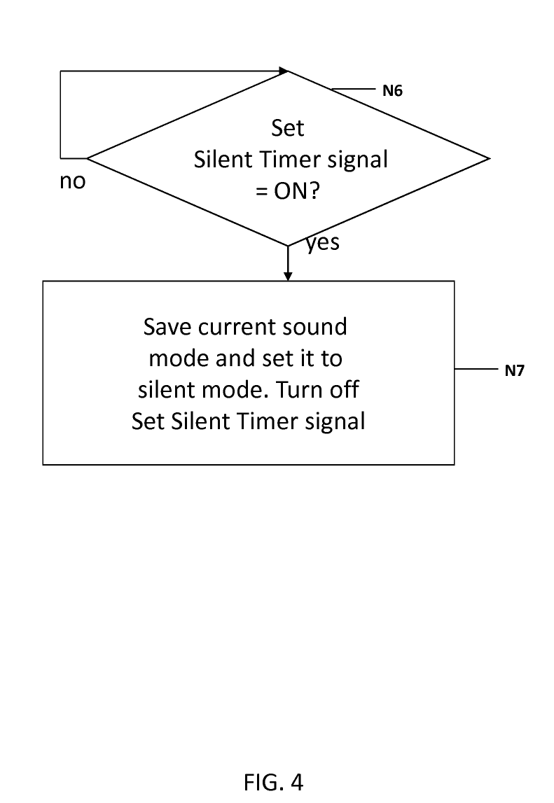

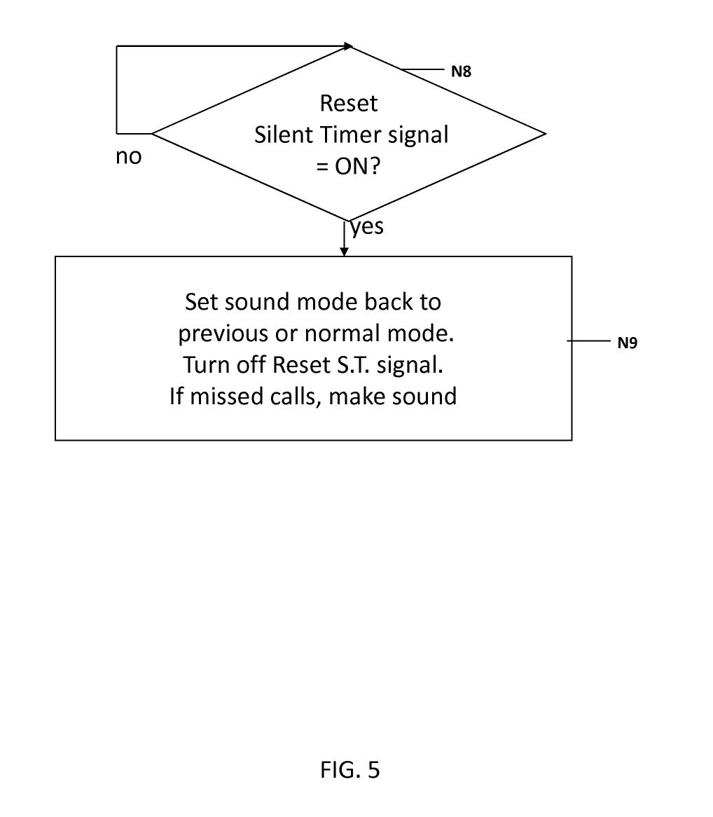

FIGS. 2-5 depict various flow charts enabled under the embodiments of the present invention. In general, after the start and end silent timer is set (steps N1-N3 of FIG. 2), program 40 will compare the same with a current time and date as if it is already checking for alerts in calendar schedule function. If the current time is the start time (step N4 of FIG. 3), program 40 will activate the silent timer, then save the current sound mode and set the sound mode to silent mode. If the current time is the end time (step N5 of FIG. 3), program 40 will activate a reset silent timer signal, which may set the sound mode back to the saved previous sound mode. The process of saving a mode is shown in FIG. 4. Specifically, program 40 will determine if the silent timer is set of “ON” (step N6 of FIG. 4). If so, the current sound mode will be saved, the electronic device 12 will be set to silent mode, and the set silent timer signal will be deactivated (step N7 of FIG. 4). FIG. 5 shows the process of setting a mode back to a saved mode. As shown, it is determined whether a reset silent timer signal is activated (step N8 of FIG. 5). If so, the sound mode is set back to a previous or normal mode, a reset silent timer signal is deactivated, and if contact attempts (e.g., calls) were missed, a signal (e.g., a sound) is generated (step N9 of FIG. 5).

As indicated above, program 40 provides many capabilities. For example, when electronic device 12 is in silent mode, it will give the user a capability to allow an emergency call to make a sound alert. If the user wishes to allow an emergency call to ring the sound, the user may turn on a “wake up silent” function, and designate a number of same incoming calls to wake up/deactivate the silent mode. Moreover, the user can make a telephone number/approved contact list (e.g., a default list may be the user's stored contacts) that the user may allow to deactivate the silent mode. Still yet, the user may configure the electronic device 12 via program 40 to deactivate the silent mode for repeated communication attempts (e.g., a predetermined number) from a single contact.

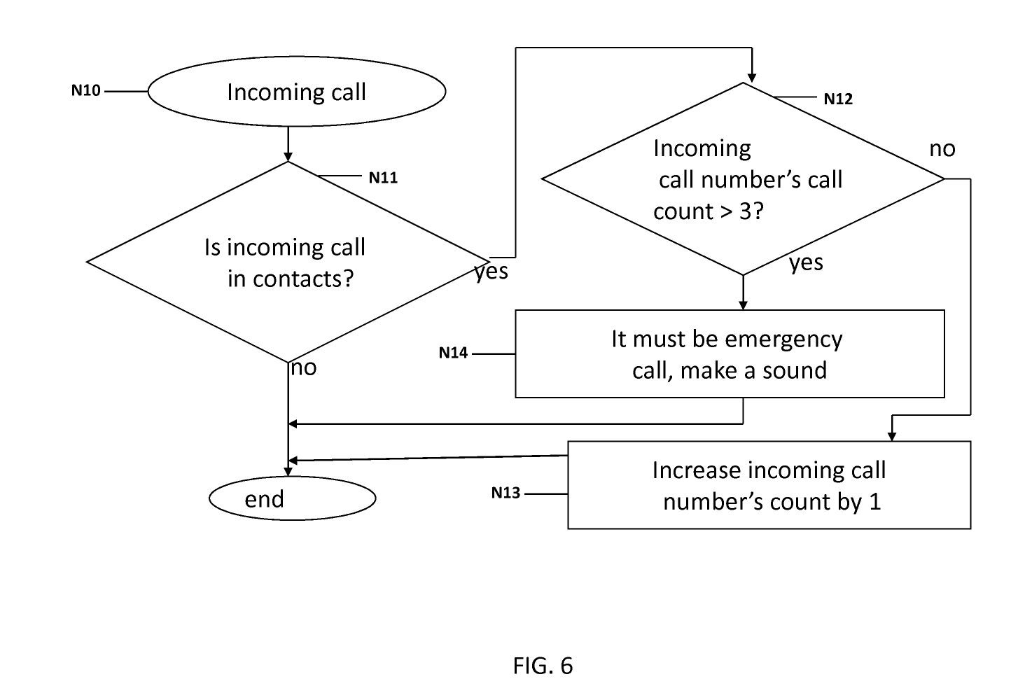

As shown in FIG. 6, an incoming communication attempt (e.g., a call) may be received (step N10). It may then be determined whether a sender of the incoming call is in the user's contacts (or list of approved senders) (step N11). If not, the process may end. If so, it may then be determined whether the incoming call number has exceeded a predetermined number of counts (e.g., 3) (step N12). If no, the counter for incoming calls from the particular incoming number may be increased by “1” (step N13). If so, program 40 may determine that the call must be an emergency call and deactivate the silent mode and make a sound or vibrate accordingly (step N14).

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A method for modifying alert modes of electronic devices, comprising:
activating a reduced alert mode enabled for deactivation for an electronic device in response to at least one predetermined criterion, the reduced alert mode reducing a sound emitted from the electronic device;
receiving a communication attempt on the electronic device;
identifying a sender of the communication attempt;
determining if the sender is on a list of approved senders from whom a communication attempt enables a deactivation of the reduced alert mode;
deactivating the reduced alert mode of the electronic device responsive to the sender being on the list of approved senders;
verifying a continuance of the at least one predetermined criterion; and
reactivating the reduced alert mode in response to the continuance of the least one predetermined criterion.

2. The method of claim 1, further comprising deactivating the reduced alert mode after a predetermined number of missed communication attempts from a single sender on the list of approved senders.

3. The method of claim 1, the at least one predetermined criterion comprising a set of time coordinates, wherein the reduced alert mode is activated based on the set of time coordinates.

4. The method of claim 1, the at least one predetermined criterion comprising a calendar entry accessible to the electronic device, wherein the reduced alert mode is activated during a time period associated with the calendar entry.

5. The method of claim 1, further comprising indicating with a signal, after the reduced mode has been deactivated, a set of communication attempts received during the reduced alert mode.

6. The method of claim 1, further comprising deactivating the reduced alert mode in response to a received emergency communication.

7. The method of claim 1, further comprising activating a heightened alert of the electronic device mode in response to a predetermined condition, the heightened alert mode increasing the sound emitted from the electronic device.

8. An electronic device, comprising:
a memory medium comprising instructions;
a bus coupled to the memory medium; and
a processor coupled to the bus that when executing the instructions causes the system to:
activate a reduced alert mode enabled for deactivation for the electronic device in response to at least one predetermined criterion, the reduced alert mode reducing a sound emitted from the electronic device;
receive a communication attempt on the electronic device;
identify a sender of the communication attempt;
determine if the sender is on a list of approved senders from whom a communication attempt enables a deactivation of the reduced alert mode;
deactivate the reduced alert mode of the electronic device responsive to the sender being on the list of approved senders;
verify a continuance of the at least one predetermined criterion; and
reactivate the reduced alert mode in response to the continuance of the least one predetermined criterion.

9. The electronic device of claim 8, the memory medium further comprising instructions for causing the system to deactivate the reduced alert mode after a predetermined number of missed communication attempts from a single sender on the list of approved senders.

10. The electronic device of claim 8, the at least one predetermined criterion comprising a set of time coordinates, wherein the reduced alert mode is activated based on the set of time coordinates.

11. The electronic device of claim 8, the at least one predetermined criterion comprising a calendar entry accessible to the electronic device, wherein the reduced alert mode is activated during a time period associated with the calendar entry.

12. The electronic device of claim 8, the memory medium further comprising instructions for causing the system to indicate with a signal, after the reduced mode has been deactivated, a set of communication attempts received during the reduced alert mode.

13. The electronic device of claim 8, the memory medium further comprising instructions for causing the system to deactivate the reduced alert mode in response to a received emergency communication.

14. The electronic device of claim 8, the memory medium further comprising instructions for causing the system to activate a heightened alert of the electronic device mode in response to a predetermined condition, the heightened alert mode increasing the sound emitted from the electronic device.

15. A computer program product for modifying alert modes of electronic devices, the computer program product comprising a computer readable storage media, and program instructions stored on the computer readable storage media, to:
activate a reduced alert mode enabled for deactivation for an electronic device in response to at least one predetermined criterion, the reduced alert mode reducing a sound emitted from the electronic device;
receive a communication attempt on the electronic device;
identify a sender of the communication attempt;
determine if the sender is on a list of approved senders from whom a communication attempt enables a deactivation of the reduced alert mode;
deactivate the reduced alert mode of the electronic device responsive to the sender being on the list of approved senders;
verify a continuance of the at least one predetermined criterion; and
reactivate the reduced alert mode in response to the continuance of the least one predetermined criterion.

16. The computer program product of claim 15, the memory medium further comprising instructions for causing the system to deactivate the reduced alert mode after a predetermined number of missed communication attempts from a single sender on the list of approved senders.

17. The computer program product of claim 15, the at least one predetermined criterion comprising a set of time coordinates, wherein the reduced alert mode is activated based on the set of time coordinates.

18. The computer program product of claim 15, the at least one predetermined criterion comprising a calendar entry accessible to the computer program product, wherein the reduced alert mode is activated during a time period associated with the calendar entry.

19. The computer program product of claim 15, the memory medium further comprising instructions for causing the system to indicate with a signal, after the reduced mode has been deactivated, a set of communication attempts received during the reduced alert mode.

20. The computer program product of claim 15, the memory medium further comprising instructions for causing the system to deactivate the reduced alert mode in response to a received emergency communication.
